(19) United States
(12) Patent Application Publication
(10) Pub. No.: US 2025/0337692 A1
(43) Pub. Date: Oct. 30, 2025

(54) METHOD, DEVICE, AND PRODUCT FOR DATA TRANSMISSION

(71) Applicant: DELL PRODUCTS L.P., ROUND ROCK, TX (US)

(72) Inventors: Tao CHEN, Beijing (CN); Ran LIU, Beijing (CN); Wensi ZHAO, Beijing (CN)

(21) Appl. No.: 18/737,257

(22) Filed: Jun. 7, 2024

(30) Foreign Application Priority Data
Apr. 26, 2024 (CN) 202410516827.1

(51) Int. Cl. H04L 47/50; G06F 9/50; G06F 15/173

(52) U.S. Cl. CPC H04L 47/50; G06F 9/5027; G06F 15/17331

(57) ABSTRACT

A method includes acquiring from a first thread a first allocation request for a queue pair. The method further includes allocating a first group of remote direct memory access (RDMA) devices for the first thread, where each RDMA device in the first group of RDMA devices corresponds to at least one queue pair. The method further includes locking a first group of queue pairs corresponding to the first group of RDMA devices, where the first thread submits first data to a first queue pair, the first queue pair corresponds to a first RDMA device in the first group of RDMA devices, and the first queue pair includes a to-be-transmitted queue and a to-be-received queue. The method further includes detecting whether the first data exists in the to-be-transmitted queue and releasing the first group of queue pairs in response to the first data existing in the to-be-transmitted queue.

### TECHNICAL FIELD

The present disclosure relates to the field of computers, and more particularly relates to a method, a device, and a computer program product for data transmission.

### BACKGROUND

In a network communication mode, a data sender needs to copy data from a user application space to a buffer zone in a kernel space, and then process it through multi-layer network protocols before it can be pushed to a network interface card for transmission. A receiver also needs to undergo a series of steps, including copying the data from a buffer zone of the network interface card to the buffer zone in the kernel space, then parsing a data packet, and finally copying the data to a user space. This process involves multiple data copies and system context switches, thereby increasing communication latency and complexity.

Remote Direct Memory Access (RDMA) technology allows data to be transmitted directly from a memory of a computer to a memory of another computer without the intervention of both operating systems. This direct memory access technology enables network communication to achieve characteristics of high-throughput and low-latency, particularly showing significant advantages in large-scale parallel computer clusters.

### SUMMARY OF THE INVENTION

Embodiments of the present disclosure provide a method, a device, and a computer program product for data transmission. In a first aspect of the embodiments of the present disclosure, a method for data transmission is provided. The method includes acquiring from a first thread a first allocation request for a queue pair. The method further includes allocating a first group of remote direct memory access (RDMA) devices for the first thread, where each RDMA device in the first group of RDMA devices corresponds to at least one queue pair. The method further includes locking a first group of queue pairs corresponding to the first group of RDMA devices, where the first thread submits first data to a first queue pair, the first queue pair corresponds to a first RDMA device in the first group of RDMA devices, and the first queue pair includes a to-be-transmitted queue and a to-be-received queue. The method further includes detecting whether the first data exists in the to-be-transmitted queue. The method further includes releasing the first group of queue pairs in response to the first data existing in the to-be-transmitted queue.

In a second aspect of the embodiments of the present disclosure, an electronic device is provided. The electronic device includes one or more processors; and a storage apparatus configured to store one or more programs, where the one or more programs, when executed by one or more processors, cause the one or more processors to execute actions. These actions include acquiring from a first thread a first allocation request for a queue pair. These actions further include allocating a first group of remote direct memory access (RDMA) devices for the first thread, where each RDMA device in the first group of RDMA devices corresponds to at least one queue pair. These actions further include locking a first group of queue pairs corresponding to the first group of RDMA devices, where the first thread submits first data to a first queue pair, the first queue pair corresponds to a first RDMA device in the first group of RDMA devices, and the first queue pair includes a to-be-transmitted queue and a to-be-received queue. These actions further include detecting whether the first data exists in the to-be-transmitted queue. These actions further include releasing the first group of queue pairs in response to the first data existing in the to-be-transmitted queue.

In a third aspect of the embodiments of the present disclosure, a computer program product is provided. The computer program product is tangibly stored on a non-volatile computer-readable medium and includes machine-executable instructions. The machine-executable instructions, when executed, cause a machine to execute actions. These actions include acquiring from a first thread a first allocation request for a queue pair. These actions further include allocating a first group of remote direct memory access (RDMA) devices for the first thread, where each RDMA device in the first group of RDMA devices corresponds to at least one queue pair. These actions further include locking a first group of queue pairs corresponding to the first group of RDMA devices, where the first thread submits first data to a first queue pair, the first queue pair corresponds to a first RDMA device in the first group of RDMA devices, and the first queue pair includes a to-be-transmitted queue and a to-be-received queue. These actions further include detecting whether the first data exists in the to-be-transmitted queue. These actions further include releasing the first group of queue pairs in response to the first data existing in the to-be-transmitted queue.

It should be understood that what is described in the summary part is neither intended to identify key or important features of the embodiments of the present disclosure, nor intended to limit the scope of the present disclosure. Other features of the present disclosure will become readily understood with reference to the following description.

### DESCRIPTION OF DRAWINGS

In conjunction with the drawings and with reference to detailed description below, the above and other features, advantages, and aspects of embodiments of the present disclosure will become more apparent. Identical or similar reference numerals in the drawings represent identical or similar elements.

FIG. 1 is a schematic diagram of an example environment in which an embodiment of the present disclosure may be implemented;

FIG. 2 is a flow chart of a method for data transmission according to some embodiments of the present disclosure;

FIG. 3 is a flow chart of detection of a transmission state according to an embodiment of the present disclosure;

FIG. 4 is a schematic diagram of data transmission according to an embodiment of the present disclosure; and

FIG. 5 is a schematic block diagram of an example device that can be configured to implement embodiments of the present disclosure.

### DETAILED DESCRIPTION

Embodiments of the present disclosure will be described in more detail below with reference to the drawings. While some embodiments of the present disclosure are shown in the drawings, it should be understood that the present disclosure may be implemented in various forms, and should not be construed as being limited to the embodiments set forth herein. On the contrary, these embodiments are provided to more thoroughly and completely understand the present disclosure. It should be understood that the drawings and embodiments of the present disclosure are only used as examples, and are not intended to limit the scope of protection of the present disclosure.

In the description of the embodiments of the present disclosure, the term “including” and similar wordings thereof should be construed as open-ended inclusions, i.e., “including but not limited to.” The term “based on” should be construed as “at least partially based on.” The term “an embodiment” or “the embodiment” should be construed as “at least one embodiment.” The terms “first,” “second,” and the like may refer to different or identical objects. Other explicit and implicit definitions may be further included below.

In related technologies, after submitting data to an RDMA device, a thread for asynchronous data transmission does not need to wait for successful transmission of the data, only needs to submit the data to a local RDMA device, and then can leave the RDMA device and end this round of data transmission. It is only necessary to lock the RDMA device and a queue pair (QP) set by the RDMA device in the process of submitting the data. This locking mechanism ensures the consistency and security of data transmission. In a communication between RDMA devices, a sender and a receiver will each set a queue pair to transmit data through these queue pairs. This locking operation is very time-consuming and computing resource-consuming. How to save computing resources in the communication process is a problem to be urgently solved.

To this end, the present disclosure presents a method for data transmission. The method in an embodiment of the present disclosure includes acquiring from a first thread a first allocation request for a queue pair. The method further includes allocating a first group of remote direct memory access (RDMA) devices for the first thread, where each RDMA device in the first group of RDMA devices corresponds to at least one queue pair. The method further includes locking a first group of queue pairs corresponding to the first group of RDMA devices, where the first thread submits first data to a first queue pair, the first queue pair corresponds to a first RDMA device in the first group of RDMA devices, and the first queue pair includes a to-be-transmitted queue and a to-be-received queue. The method further includes detecting whether the first data exists in the to-be-transmitted queue. The method further includes releasing the first group of queue pairs in response to the first data existing in the to-be-transmitted queue. Therefore, in a scenario of asynchronous data transmission, the first group of RDMA devices is allocated to the thread requesting data transmission and the first group of queue pairs is locked, so that the thread for asynchronous data transmission can be switched to another queue pair without an unlocking operation and a locking operation, to submit the data to the to-be-transmitted queue. Therefore, the method disclosed herein can be used to greatly reduce the locking frequency and save the computing resources.

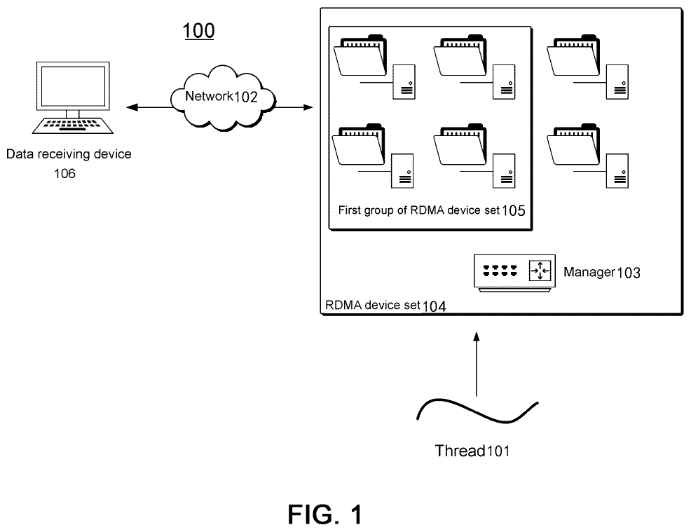

FIG. 1 is a schematic diagram of example environment 100 in which an embodiment of the present disclosure may be implemented. As shown in FIG. 1, environment 100 may include thread 101, network 102, manager 103, RDMA device set 104, first group of RDMA devices 105, and data receiving device 106. RDMA device set 104 is communicatively coupled to data receiving device 106 through network 102. Network 102 may be, for example, a wide area network (WAN), a local area network (LAN), a wireless network, a public telephone network, an intranet, and any other type of network known to those skilled in the art.

In this embodiment, the method for data transmission is mainly executed by manager 103. Manager 103 may be, for example, a widget integrated in RDMA device set 104, and is configured to manage RDMA device set 104. Manager 103 may apply this method, for example, in a process of mirroring storage data. In this embodiment, the method executed by manager 103 includes the following steps. Manager 103 acquires from first thread (hereinafter referred to as “thread”) 101 a first allocation request for a queue pair. RDMA technology provides an ability to directly access a remote memory. When thread 101 needs to transmit data, a thread of a sender is allowed to write the data directly into a memory of a receiver. This operation is completed directly at a hardware level, bypassing the intervention of a kernel and a CPU of an operating system. In order to manage RDMA device set 104, thread 101 may first communicate with manager 103 for control to request to be allocated with a queue pair.

Manager 103 allocates a first group of remote direct memory access (RDMA) devices for first thread 101, where each RDMA device in the first group of RDMA devices corresponds to at least one queue pair. In this embodiment, first group of RDMA devices 105 is allocated to thread 101.

Manager 103 locks a first group of queue pairs corresponding to first group of RDMA devices 105, where first thread 101 submits first data to a first queue pair, the first queue pair corresponds to a first RDMA device in first group of RDMA devices 105, and the first queue pair includes a to-be-transmitted queue and a to-be-received queue. Each RDMA device in RDMA device set 104 may be provided with several queue pairs respectively for transmitting data. In some embodiments, first group of RDMA devices 105 includes four RDMA devices, and the first group of queue pairs includes four queue pairs corresponding to the four RDMA devices respectively. In this way, once one RDMA device fails, thread 101 can be flexibly switched to another RDMA device to transmit data without repeatedly unlocking and locking, which can save a lot of computing resources.

Manager 103 detects whether the first data exists in the to-be-transmitted queue. If data is to be transmitted via the RDMA device, the data needs to be placed in the to-be-transmitted queue for transmission. The first queue pair includes the to-be-transmitted queue and the to-be-received queue. After thread 101 successfully submits data (i.e., the first data) to the first RDMA device, the data will be placed in the to-be-transmitted queue of the first queue pair for transmission.

When the first data exists in the to-be-transmitted queue, manager 103 releases the first group of queue pairs. If the first data exists in the to-be-transmitted queue, it means that the first data has been submitted, a data transmission task of thread 101 for asynchronous data transmission has been completed, and it is not necessary to further check whether a completion data entity corresponding to the first data exists in a completion queue. Therefore, it is not necessary to continue locking the first group of queue pairs, and the first group of queue pairs can be released.

As shown in FIG. 1, in environment 100, network 102 may be used to transmit data between RDMA device set 104 and data receiving device 106. Network 102 has a theoretical bandwidth. The theoretical bandwidth refers to a maximum transmission speed supported by network 102, represents the largest data volume that can be transmitted by network 102 under ideal conditions, and is usually measured in bits per second (bps). For example, if the theoretical bandwidth of network 102 is 100 Mbps, it means that the network can transmit one hundred megabits of data per second under ideal conditions. However, in practice, because other factors (such as signal interference, bandwidth sharing, transmission delay, etc.) may exist in the network, the actual transmission speed of 100 Mbps may not be achieved.

It is understood by those of ordinary skills in the art that manager 103 can be integrated into RDMA device set 104 and uses a processor of RDMA device set 104 without using a processor of other devices, thereby achieving data transmission without consuming computing resources of other devices, such as mirroring storage of data.

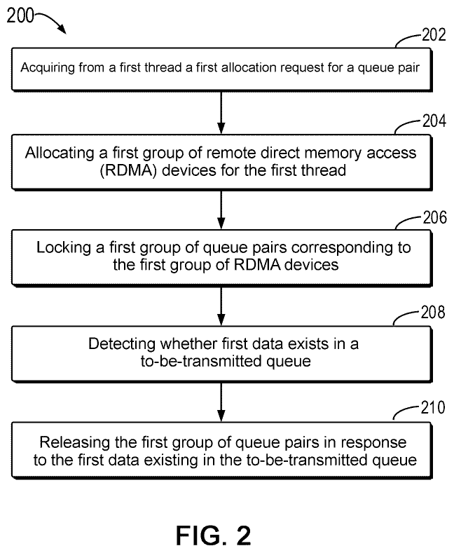

FIG. 2 is a flow chart of a method for data transmission according to some embodiments of the present disclosure. As shown in FIG. 2, flow chart 200 includes blocks 202-210. At block 202, a first allocation request for a queue pair is acquired from a first thread. In this operation, the thread does not need to indicate information such as an identifier of a to-be-used RDMA device in the first allocation request, as required in related technologies, but only needs to inform, for example, the manager that the thread needs to be allocated with a queue pair to submit data.

At block 204, a first group of remote direct memory access (RDMA) devices is allocated for the first thread, where each RDMA device in the first group of RDMA devices corresponds to at least one queue pair. Usually, one RDMA device may be provided with a plurality of queue pairs, so that one or more queue pairs may be selected for each RDMA device from the first group of RDMA devices as queue pairs to be locked subsequently.

At block 206, a first group of queue pairs corresponding to the first group of RDMA devices is locked, where the first thread submits first data to a first queue pair, the first queue pair corresponds to a first RDMA device in the first group of RDMA devices, and the first queue pair includes a to-be-transmitted queue and a to-be-received queue. The first RDMA device is any one RDMA device in the first group of RDMA devices. The first queue pair is a queue pair corresponding to the RDMA device. The first queue pair is a queue pair in the first group of queue pairs. After the queue pairs are locked, the thread selects the first queue pair as a queue pair for data transmission, and submits the first data to the first RDMA device corresponding to the first queue pair, instead of submitting the first data to all queue pairs or some queue pairs that are locked. The locking operation ensures that the thread exclusively occupies these queue pairs during data transmission, thereby preventing other threads from competing for queue pairs and ensuring the stability and reliability of data transmission. The first data here may be any type of data packet, such as a file, a video stream, or a database record.

At block 208, whether the first data exists in the to-be-transmitted queue is detected. If the first data exists in the to-be-transmitted queue, it means that the first RDMA device has successfully received the first data submitted by the thread. If the first data does not exist in the to-be-transmitted queue, there are two possibilities: one possibility is that transmission of the first data has been completed, so that the first data cannot be found in the to-be-transmitted queue; and the other possibility is that a failure occurs during submission of the data by the thread, so that the submission fails. In this embodiment, the thread will detect the to-be-transmitted queue of the first RDMA device immediately (within a short period of time) after submitting the data, so that the second possibility will most likely occur.

At block 210, the first group of queue pairs is released in response to the first data existing in the to-be-transmitted queue. Once it is detected that the first data exists in the to-be-transmitted queue, it is known that the first data has been successfully submitted to the first RDMA device. In this case, a release operation can be triggered to release the previously locked first group of queue pairs back to a queue pair resource pool, so that the thread can process other tasks, and other threads can reapply for and use these queue pairs.

In the embodiment, in a scenario of asynchronous data transmission, the first group of RDMA devices is allocated to the thread requesting data transmission and the first group of queue pairs is locked, so that the thread for asynchronous data transmission can be switched to another queue pair, without an unlocking operation and a locking operation, to submit the data to the to-be-transmitted queue. Therefore, the method disclosed herein can be used to greatly reduce the locking frequency and save computing resources.

In some embodiments, each group of queue pairs is provided with a dedicated iterator. In the first group of queue pairs in this embodiment, assuming that the iterator currently indicates the first queue pair, when the first queue pair fails, the iterator is modified to indicate a second queue pair in the first group of queues, where the second queue pair is different from the first queue pair. Further, the thread submits the first data to a second queue. That is, the thread determines an object to which the data is to be submitted based on an instruction of the iterator. In the case where the first group of queue pairs includes eight queue pairs, the iterator can be incremented by 1 with each iteration, and resets to 1 when it hits 8 and needs to be re-iterated again. In this embodiment, the iterator is arranged to automatically replace a queue pair in a locked single group of queue pairs. That is, the thread neither needs to repeatedly request to lock queue pairs out of the first group of queue pairs, nor needs to present any allocation request within the first group of queue pairs, thereby saving the computing resources.

In some embodiments, only one queue pair may be selected for each RDMA device to form the first group of queue pairs. In some cases, the reason why a queue pair cannot be used to transmit data is that a corresponding RDMA device fails, so that none of the queue pairs provided for the RDMA device can transmit data. This may cause a re-allocated RDMA device to still be unavailable for data transmission after the thread fails in submission and switches the queue pair. Therefore, repeated locking and unlocking events may occur for many threads, thereby greatly wasting the computing resources. In this embodiment, each queue pair is limited to RDMA devices that are different from each other, so that when the queue pair is switched, the purpose of switching the RDMA device is simultaneously achieved, which can increase the probability of switching to a successful queue pair, thereby reducing the number of switches and saving the computing resources.

In some cases, for example, in a case of backing up data on a storage node, when an RDMA device for transmission fails, if only a part of the data has been transmitted, it is necessary to resubmit the first data after switching the queue pair. In order to reduce repeated submissions and reduce computing resource consumption, the thread is provided with a first list in some embodiments. The first list indicates a transmission state of each piece of data of the first data, that is, whether the transmission is successful or not. In this embodiment, it is not only necessary to detect whether the submission is successful through the to-be-transmitted queue, but also necessary to detect whether the transmission is successful. This embodiment includes detecting whether the first RDMA device has transmitted the first data. This embodiment further includes updating, if the first RDMA device has transmitted a first portion of data of the first data, the first list to indicate successful transmission of the first portion of data, where the first portion of data includes at least one piece of data. This embodiment further includes submitting, by the thread, data of the first data other than the first portion of data to the second queue pair based on the first list. In this embodiment, the first list can be set to record which data has been successfully transmitted. Therefore, after the queue pair is switched for a reason, only the remaining data may be transmitted to the queue pair switched to, which can reduce repeated transmission and reduce the computing resource consumption.

Similarly, for example, in a case of backing up data on a storage node, the thread often needs to transmit a data object batch by batch, for example, the data is divided into a total of ten batches (the first data to tenth data), where the ten batches of data are inherently coherent, their sequence cannot be disrupted, and otherwise all of them will be re-transmitted. In this case, it is necessary to ensure that the thread submits the data to the same queue pair each time. In this regard, in some embodiments, the first group of queue pairs is provided with an iterator, and assuming that the iterator currently indicates a third queue pair, this embodiment includes acquiring from the thread a second allocation request for the queue pair. This embodiment further includes allocating the first group of RDMA devices to the first thread. This embodiment further includes locking the first group of queue pairs, i.e., locking the same group of queues for the thread. This embodiment further includes modifying the iterator of the first group of queue pairs to indicate the first queue pair, in response to no occurrence of a failure in the first queue pair, where the first thread submits second data to the first queue pair, thus ensuring that the thread submits the data to the same queue pair each time. This embodiment further includes detecting whether the second data exists in the to-be-transmitted queue, and releasing the first group of queue pairs in response to the second data existing in the to-be-transmitted queue.

In this embodiment, the same queue pair in the same group of queue pairs is allocated to the thread to ensure that the transmission sequence of respective pieces of data is consistent with the internal logical sequence of respective pieces of data, and large blocks of data objects can be transmitted batch by batch, which is very beneficial in a process of mirroring storage data.

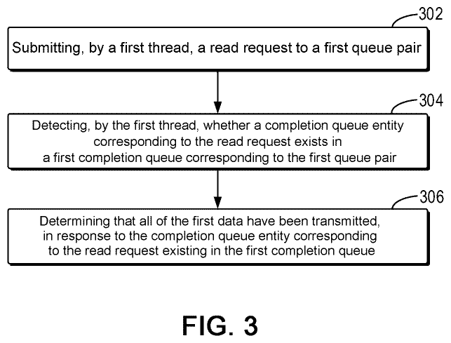

Although the thread can leave the RDMA device to process other tasks after submitting the data in the above embodiments, it eventually will return to the RDMA device to detect whether the submitted data has been successfully transmitted. The thread cannot know a transmission state of the submitted data in advance, so that it may be necessary to continuously poll completion queues to find a completion queue entity corresponding to the first data, which will consume a lot of computing resources. FIG. 3 is a flow chart of detection of a transmission state according to an embodiment of the present disclosure, including blocks 302-306. In this embodiment, each RDMA device transmits data in accordance with a peripheral component interconnect express.

At block 302, a first thread submits a read request to a first queue pair, where the read request is used to read data of a preset bit size. The read request indicates a request for reading data of a target size. At block 304, the first thread detects whether a completion queue entity corresponding to the read request exists in a first completion queue corresponding to the first queue pair. In this embodiment, it is not necessary to detect one or more completion queue entities corresponding to the submitted first data. It is only necessary to detect whether a completion queue entity corresponding to the read request exists in the first completion queue.

At block 306, it is determined that all of the first data have been transmitted in response to the completion queue entity corresponding to the read request existing in the first completion queue. Because when both the RDMA mechanism and the peripheral component interconnect express (PCIe) are used, using the characteristic that the read request will be processed only after all write requests are completed, the inventors directly initiate the read request, detect the completion queue entity corresponding to the read request, and can determine that all of the first data have been transmitted if the completion queue entity is detected at block 306, or otherwise can determine that the first data has not been transmitted. Therefore, in this embodiment, it is not necessary to repeatedly detect the first completion queue many times to detect a plurality of completion queue entities corresponding to the first data, which can save a large amount of computing resources. In some embodiments, the read request is a read request having a size of 0 bit. In this case, a read bit size of 0 bit will significantly increase the processing speed and quickly detect the completion queue entity of the read request, which can improve the detection efficiency. In some embodiments, a read bit size is between 1-8 bits, which can also improve the detection efficiency.

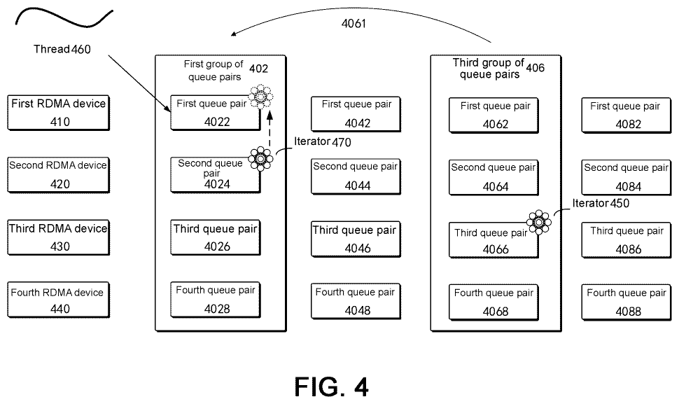

FIG. 4 is a schematic diagram of data transmission according to an embodiment of the present disclosure. Iterator 450 and iterator 470 are shown. Third group of queue pairs 406 includes four queue pairs, namely first queue pair 4062, second queue pair 4064, third queue pair 4066, and fourth queue pair 4068. Queue pairs 4022, 4024, 4026, and 4028 correspond to first RDMA device 410; queue pairs 4042, 4044, 4046, and 4048 correspond to second RDMA device 420; queue pairs 4062, 4064, 4066, and 4068 correspond to third RDMA device 430; and queue pairs 4082, 4084, 4086, and 4088 correspond to fourth RDMA device 440. Similarly, first group of queue pairs 402 includes four queue pairs, namely first queue pair 4022, second queue pair 4024, third queue pair 4026, and fourth queue pair 4028. The rest will not be repeated.

A previous thread (not shown) once submitted data to third queue pair 4066 in third group of queue pairs 406. After the submission is completed, a current value of iterator 450 is 4. Thread 460 previously submitted first data to first queue pair 4022 in first group of queue pairs 402. In this embodiment, thread 460 now needs to submit second data, which belongs to the same data block as the first data. As shown by arrow 4061, first group of queue pairs 402 can be locked for thread 460, and at the same time, iterator 470 of the first group of queue pairs is updated to a current value of 1, so that thread 460 can continue to submit the second data to first group of queue pairs 4022. This ensures the sequential consistency of transmission data in different batches of thread 460.

In order to reduce the failure rate of queue pairs, preprocessing operations can be taken before allocation of RDMA devices. In some embodiments, each RDMA device in an RDMA device set communicates with a remote device (e.g., an RDMA device of a receiver) through a network connection, and the preprocessing operations include detecting a communication state of each network connection. The preprocessing operations further include determining a to-be-allocated first group of RDMA devices based on the communication state. RDMA devices in an abnormal communication state are first eliminated, and then the first group of RDMA devices is allocated, which can ensure that the allocated first group of RDMA devices has a low failure rate, thereby reducing the frequency of subsequent locking and unlocking.

The present disclosure further provides an embodiment for transmission. In some embodiments, a transmission state of transmission data of the first data in the to-be-transmitted queue is detected. If transmission of the transmission data fails, the data is re-transmitted by the first RDMA. The re-transmission operation can be repeated up to a preset number of times, such as 5 times. If the transmission data is successfully transmitted, a completion queue entity for the transmission data is constructed in a first completion queue. The repeated transmission mechanism can avoid full re-transmission of the whole data caused by sporadic transmission failure.

In some embodiments, the method for data transmission further includes accessing the first completion queue. The method for data transmission further includes retrieving a completion queue entity for each piece of data of the first data from the first completion queue. The method for data transmission further includes eliminating the completion queue entity for each piece of data in response to the completion queue entity for each piece of data being successfully retrieved. Additionally, in some embodiments, if no completion queue entity for the last piece of data of the first data is found, the first completion queue is repeatedly searched. This embodiment provides a specific solution for validating whether the first data is successfully transmitted, and provides a complete validation mechanism for eliminating the queue entity when the completion queue entity is retrieved and repeatedly searching the first completion queue when the queue entity is not found.

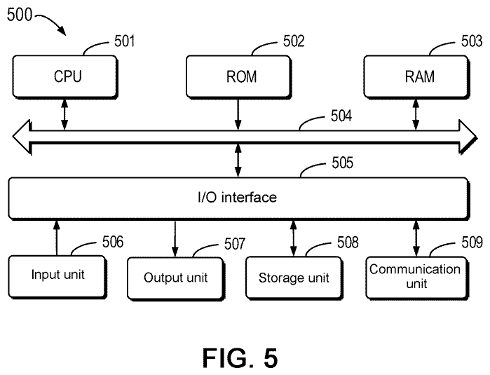

FIG. 5 is a schematic block diagram of example device 500 that can be configured to implement embodiments of the present disclosure. As shown in the figure, device 500 includes computing unit 501, which may execute various appropriate actions and processing in accordance with computer program instructions stored in read-only memory (ROM) 502 or computer program instructions loaded into random access memory (RAM) 503 from storage unit 508. RAM 503 may further store various programs and data required by operations of device 500. Computing unit 501, ROM 502, and RAM 503 are connected to each other through bus 504. Input/output (I/O) interface 505 is also connected to bus 504.

A number of components in device 500 are connected to I/O interface 505, including: input unit 506, such as a keyboard or a mouse; output unit 507, such as various types of displays or speakers; storage unit 508, such as a magnetic disk or an optical disk; and communication unit 509, such as a network card, a modem, or a wireless communication transceiver. Communication unit 509 allows device 500 to exchange information/data with other devices via a computer network such as the Internet and/or various telecommunication networks.

Computing unit 501 may be various general-purpose and/or special-purpose processing components having a processing power and a computing power. Some examples of computing unit 501 include, but are not limited to, a central processing unit (CPU), a graphics processing unit (GPU), various special-purpose artificial intelligence (AI) computing chips, various computing units running a machine learning model algorithm, a digital signal processor (DSP), and any appropriate processor, controller, micro-controller, and the like. Computing unit 501 executes various methods and processing described above, such as method 200. For example, in some embodiments, method 200 may be implemented as a computer software program that is tangibly included in a machine-readable medium such as storage unit 508. In some embodiments, part or all of the computer program may be loaded and/or installed onto device 500 via ROM 502 and/or communication unit 509. When the computer program is loaded into RAM 503 and executed by computing unit 501, one or more steps of method 200 described above may be executed. Alternatively, in other embodiments, computing unit 501 may be configured to execute method 200 by any other appropriate approach (e.g., by means of firmware).

The functions described hereinabove may at least partially be executed by one or more hardware logic components. For example, non-restrictively, example types of usable hardware logic components include: a field programmable gate array (FPGA), an application specific integrated circuit (ASIC), an application specific standard product (ASSP), a system-on-chip system (SOC), a loading programmable logic device (CPLD), and so on.

Program codes for implementing the method of the present disclosure may be compiled using any combination of one or more programming languages. The program codes may be provided to a processor or controller of a general-purpose computer, a special-purpose computer, or other programmable data processing apparatuses, such that the program codes, when executed by the processor or controller, cause the functions/operations specified in the flow charts and/or block diagrams to be implemented. The program codes may be completely executed on a machine, partially executed on a machine, partially executed as a separate software package on a machine and partially executed on a remote machine, or completely executed on a remote machine or server.

In the context of the present disclosure, the machine-readable medium may be a tangible medium which may contain or store a program for use by, or use in combination with, an instruction execution system, apparatus, or device. The machine-readable medium may be a machine-readable signal medium or a machine-readable storage medium. The machine-readable medium may include, but is not limited to, electronic, magnetic, optical, electromagnetic, infrared, or semiconductor systems, apparatuses, or devices, or any appropriate combination of the above. A more specific example of the machine-readable storage medium will include an electrical connection based on one or more pieces of wire, a portable computer disk, a hard disk, a random-access memory (RAM), a read-only memory (ROM), an erasable programmable read-only memory (EPROM or flash memory), an optical fiber, a portable compact disc read-only memory (CD-ROM), an optical storage device, a magnetic storage device, or any appropriate combination of the above. Further, while the operations are depicted in a particular order, it should be understood that the operations are requested to be executed in the shown particular order or in a sequential order, or that all illustrated operations are requested to be executed to achieve desired results. In a certain environment, multitasking and parallel processing may be advantageous. Similarly, while a number of specific implementation details are included in the above description, these implementation details should not be construed as limiting the scope of the present disclosure. Some features described in the context of separate embodiments may also be implemented in combination in a single implementation. On the contrary, various features described in the context of a single implementation may also be implemented in a plurality of implementations separately or in any appropriate subcombination.

The computer-readable program instructions described herein may be downloaded from a computer-readable storage medium to various computing/processing devices or downloaded to an external computer or external storage device via a network, such as the Internet, a local area network, a wide area network, and/or a wireless network. The network may include copper transmission cables, fiber optic transmission, wireless transmission, routers, firewalls, switches, gateway computers, and/or edge servers. A network adapter card or network interface in each computing/processing device receives computer-readable program instructions from a network and forwards the computer-readable program instructions for storage in a computer-readable storage medium in the computing/processing device.

The computer program instructions for executing the operations of the present disclosure may be assembly instructions, instruction set architecture (ISA) instructions, machine instructions, machine-dependent instructions, microcode, firmware instructions, status setting data, or source code or object code written in any combination of one or more programming languages, the programming languages including object-oriented programming language such as Smalltalk and C++, and conventional procedural programming languages such as the “C” language or similar programming languages. The computer-readable program instructions may be executed entirely on a user computer, partially on a user computer, as a stand-alone software package, partially on a user computer and partially on a remote computer, or entirely on a remote computer or a server. In the case where a remote computer is involved, the remote computer can be connected to a user computer through any kind of networks, including a local area network (LAN) or a wide area network (WAN), or can be connected to an external computer (for example, connected through the Internet using an Internet service provider). In some embodiments, an electronic circuit, such as a programmable logic circuit, a field programmable gate array (FPGA), or a programmable logic array (PLA), is customized by utilizing status information of the computer-readable program instructions. The electronic circuit may execute the computer-readable program instructions to implement various aspects of the present disclosure.

Various aspects of the present disclosure are described herein with reference to flow charts and/or block diagrams of the method, the apparatus (system), and the computer program product implemented according to the embodiments of the present disclosure. It should be understood that each block of the flow charts and/or the block diagrams and a combination of blocks in the flow charts and/or the block diagrams may be implemented by computer-readable program instructions.

The computer-readable program instructions may be provided to a processing unit of a general-purpose computer, a special-purpose computer, or other programmable data processing apparatuses to produce a machine, such that the instructions, when executed by the processing unit of the computer or the other programmable data processing apparatuses, generate an apparatus implementing the functions/actions specified in one or more blocks in the flow charts and/or block diagrams. These computer-readable program instructions may also be stored in a computer-readable storage medium, and these instructions cause a computer, a programmable data processing apparatus, and/or other devices to operate in a particular manner; and thus, the computer-readable medium storing instructions includes an article of manufacture that includes instructions implementing various aspects of the functions/actions specified in one or more blocks in the flow charts and/or block diagrams.

The computer-readable program instructions may also be loaded onto a computer, other programmable data processing apparatuses, or other devices, such that a series of operations or steps may be executed on the computer, the other programmable data processing apparatuses, or the other devices to produce a computer-implemented process, and such that the instructions executed on the computer, the other programmable data processing apparatuses, or the other devices may implement the functions/actions specified in one or more blocks in the flow charts and/or block diagrams.

The flow charts and block diagrams in the figures show the architectures, functions, and operations of possible implementations of the systems, methods, and computer program products according to various embodiments of the present disclosure. In this regard, each block in the flow charts or block diagrams may represent a module, a program segment, or a portion of an instruction, the module, the program segment, or the portion of the instruction including one or more executable instructions for implementing specified logical functions. In some alternative implementations, functions annotated in the blocks may also occur in a sequence different from the sequence annotated in the figures. For example, two successive blocks may actually be executed substantially in parallel, and sometimes they may also be executed in a reverse order, which depends on involved functions. It should be further noted that each block in the block diagrams and/or flow charts as well as a combination of blocks in the block diagrams and/or flow charts may be implemented by using a special hardware-based system that executes specified functions or actions, or implemented using a combination of special hardware and computer instructions.

The embodiments of the present disclosure have been described above. The above description is illustrative, rather than exhaustive, and is not limited to the disclosed embodiments. Numerous modifications and alterations are apparent to those of ordinary skills in the art without departing from the scope and spirit of the illustrated embodiments. The selection of the terms used herein is intended to best explain the principles and practical applications of the embodiments or the improvements to technologies on the market, or to enable other persons of ordinary skills in the art to understand the embodiments disclosed herein.

1. A method for data transmission, comprising:
acquiring from a first thread a first allocation request for a queue pair;
allocating a first group of remote direct memory access (RDMA) devices for the first thread, wherein each RDMA device in the first group of RDMA devices corresponds to at least one queue pair;
locking a first group of queue pairs corresponding to the first group of RDMA devices, wherein the first thread submits first data to a first queue pair, the first queue pair corresponds to a first RDMA device in the first group of RDMA devices, and the first queue pair comprises a to-be-transmitted queue and a to-be-received queue;
detecting whether the first data exists in the to-be-transmitted queue; and
releasing the first group of queue pairs in response to the first data existing in the to-be-transmitted queue.

2. The method according to claim 1, wherein the first group of queue pairs is provided with an iterator, the iterator indicates the first queue pair, and the method further comprises:
modifying the iterator of the first group of queue pairs to indicate a second queue pair in the first group of queue pairs, in response to occurrence of a failure in the first queue pair, wherein the second queue pair is different from the first queue pair; and
submitting, by the first thread, the first data to the second queue pair.

3. The method according to claim 2, wherein the first thread is provided with a first list, the first list indicates a transmission state of each piece of data of the first data, and after detecting whether the first data exists in the to-be-transmitted queue, the method further comprises:
detecting whether the first RDMA device has transmitted the first data; and
updating, in response to the first RDMA device having transmitted a first portion of data of the first data, the first list to indicate successful transmission of the first portion of data, wherein the first portion of data comprises at least one piece of data;
wherein submitting, by the first thread, the first data to the second queue pair comprises:
submitting, by the first thread, data of the first data other than the first portion of data to the second queue pair based on the first list.

4. The method according to claim 1, wherein each RDMA device transmits data in accordance with a peripheral component interconnect express, and the method further comprises:
submitting, by the first thread, a read request to the first queue pair, wherein the read request is used to read data of a preset bit size;
detecting, by the first thread, whether a completion queue entity corresponding to the read request exists in a first completion queue corresponding to the first queue pair; and
determining that all of the first data have been transmitted, in response to a completion queue entity corresponding to the read request existing in the first completion queue.

5. The method according to claim 1, wherein the first group of queue pairs is provided with an iterator, the iterator indicates a third queue pair, and the method further comprises:
acquiring from the first thread a second allocation request for a queue pair;
allocating the first group of RDMA devices for the first thread;
locking the first group of queue pairs;
modifying the iterator of the first group of queue pairs to indicate the first queue pair, in response to no occurrence of a failure in the first queue pair, wherein the first thread submits second data to the first queue pair;
detecting whether the second data exists in the to-be-transmitted queue; and
releasing the first group of queue pairs in response to the second data existing in the to-be-transmitted queue.

6. The method according to claim 1, wherein an RDMA device corresponding to each queue pair in the first group of queue pairs is different from each other.

7. The method according to claim 1, wherein the RDMA device communicates with a remote device through a network connection, and after acquiring from the first thread the first allocation request for the queue pair, the method further comprises:
detecting a communication state of each network connection;
determining the to-be-allocated first group of RDMA devices based on the communication state.

8. The method according to claim 1, wherein the method further comprises:
detecting a transmission state of transmission data of the first data in the to-be-transmitted queue;
re-transmitting the transmission data by the first RDMA in response to transmission failure of the transmission data; and
constructing a completion queue entity for the transmission data in response to successful transmission of the transmission data.

9. The method according to claim 8, wherein the method further comprises:
accessing a first completion queue;
retrieving a completion queue entity for each piece of data of the first data from the first completion queue; and
eliminating the completion queue entity for each piece of data in response to the completion queue entity for each piece of data being retrieved.

10. The method according to claim 9, wherein the method further comprises:
repeatedly searching the first completion queue in response to no completion queue entity for the last piece of data of the first data being found.

11. An electronic device, comprising:
at least one processor; and
a memory coupled to the at least one processor and having instructions stored thereon, wherein the instructions, when executed by the at least one processor, cause the electronic device to execute actions, and the actions comprise:
acquiring from a first thread a first allocation request for a queue pair;
allocating a first group of remote direct memory access (RDMA) devices for the first thread, wherein each RDMA device in the first group of RDMA devices corresponds to at least one queue pair;
locking a first group of queue pairs corresponding to the first group of RDMA devices, wherein the first thread submits first data to a first queue pair, the first queue pair corresponds to a first RDMA device in the first group of RDMA devices, and the first queue pair comprises a to-be-transmitted queue and a to-be-received queue;
detecting whether the first data exists in the to-be-transmitted queue; and
releasing the first group of queue pairs in response to the first data existing in the to-be-transmitted queue.

12. The electronic device according to claim 11, wherein the first group of queue pairs is provided with an iterator, the iterator indicates the first queue pair, and the actions further comprise:
modifying the iterator of the first group of queue pairs to indicate a second queue pair in the first group of queue pairs, in response to occurrence of a failure in the first queue pair, wherein the second queue pair is different from the first queue pair; and
submitting, by the first thread, the first data to the second queue pair.

13. The electronic device according to claim 12, wherein the first thread is provided with a first list, the first list indicates a transmission state of each piece of data of the first data, and after detecting whether the first data exists in the to-be-transmitted queue, the actions further comprise:
detecting whether the first RDMA device has transmitted the first data; and
updating, in response to the first RDMA device having transmitted a first portion of data of the first data, the first list to indicate successful transmission of the first portion of data, wherein the first portion of data comprises at least one piece of data;
wherein submitting, by the first thread, the first data to the second queue pair comprises:
submitting, by the first thread, data of the first data other than the first portion of data to the second queue pair based on the first list.

14. The electronic device according to claim 11, wherein each RDMA device transmits data in accordance with a peripheral component interconnect express, and the actions further comprise:
submitting, by the first thread, a read request to the first queue pair, wherein the read request is used to read data of a preset bit size;
detecting, by the first thread, whether a completion queue entity corresponding to the read request exists in a first completion queue corresponding to the first queue pair; and
determining that all of the first data have been transmitted, in response to a completion queue entity corresponding to the read request existing in the first completion queue.

15. The electronic device according to claim 11, wherein the first group of queue pairs is provided with an iterator, the iterator indicates a third queue pair, and the actions further comprise:
acquiring from the first thread a second allocation request for a queue pair;
allocating the first group of RDMA devices for the first thread;
locking the first group of queue pairs;
modifying the iterator of the first group of queue pairs to indicate the first queue pair, in response to no occurrence of a failure in the first queue pair, wherein the first thread submits second data to the first queue pair;
detecting whether the second data exists in the to-be-transmitted queue; and
releasing the first group of queue pairs in response to the second data existing in the to-be-transmitted queue.

16. The electronic device according to claim 11, wherein an RDMA device corresponding to each queue pair in the first group of queue pairs is different from each other.

17. The electronic device according to claim 11, wherein the RDMA device communicates with a remote device through a network connection, and after acquiring from the first thread the first allocation request for the queue pair, the actions further comprise:
detecting a communication state of each network connection; and
determining the to-be-allocated first group of RDMA devices based on the communication state.

18. The electronic device according to claim 11, wherein the actions further comprise:
detecting a transmission state of transmission data of the first data in the to-be-transmitted queue;
re-transmitting the transmission data by the first RDMA in response to transmission failure of the transmission data; and
constructing a completion queue entity for the transmission data in response to successful transmission of the transmission data.

19. The electronic device according to claim 18, wherein the actions further comprise:
accessing a first completion queue;
retrieving a completion queue entity for each piece of data of the first data from the first completion queue; and
eliminating the completion queue entity for each piece of data in response to the completion queue entity for each piece of data being retrieved.

20. A non-volatile computer-readable medium having machine-executable instructions stored therein, wherein the machine-executable instructions, when executed by a processor, cause the processor to perform actions, the actions comprising:
acquiring from a first thread a first allocation request for a queue pair;
allocating a first group of remote direct memory access (RDMA) devices for the first thread, wherein each RDMA device in the first group of RDMA devices corresponds to at least one queue pair;
locking a first group of queue pairs corresponding to the first group of RDMA devices, wherein the first thread submits first data to a first queue pair, the first queue pair corresponds to a first RDMA device in the first group of RDMA devices, and the first queue pair comprises a to-be-transmitted queue and a to-be-received queue;
detecting whether the first data exists in the to-be-transmitted queue; and
releasing the first group of queue pairs in response to the first data existing in the to-be-transmitted queue.
